(19) United States
(12) Patent Application Publication
(10) Pub. No.: US 2013/0037572 A1
(43) Pub. Date: Feb. 14, 2013

(54) MINIATURE DISPENSER FOR LIQUIDS OR POWDERS WITH SEPERABLE BODY AND RESERVOIR FOR THE LIQUID AND POWDER

(71) Applicants: John Yapaola, Mitaka-shi, NJ (US); David Conroy, Brooklyn, NY (US)

(72) Inventors: John Yapaola, Mitaka-shi, NJ (US); David Conroy, Brooklyn, NY (US)

(73) Assignee: PWRISTINE INC., Kinnelon, NJ (US)

(21) Appl. No.: 13/497,649

(22) PCT Filed: Sep. 24, 2010
(86) PCT No.: PCT/US10/50193

§ 371 Date: Oct. 30, 2012

Related U.S. Application Data
(60) Provisional application No. 61/245,508, filed on Sep. 24, 2009.
(60) Provisional application No. 61/303,110, filed on Feb. 10, 2010.
(60) Provisional application No. 61/379,658, filed on Sep. 2, 2010.

(51) Int. Cl. B67D 7/84; B67D 7/60

(52) U.S. Cl. 222/175; 222/387

(57) ABSTRACT

A miniature dispenser for dispensing fluid materials such as liquids or powders. The dispenser has a body which contains a piston and a material reservoir which is separable from the body and contains the fluid material. The material reservoir includes the passages, valves, and nozzles through which the material being dispensed flows and also includes an integral collapsible material container. A user may assemble the body to different material reservoirs and each material reservoir may be tailored to the properties of the material it contains. The dispenser is small enough to be worn as part of a bracelet or to be dipped to a pocket, belt, backpack, or purse.

### CROSS-REFERENCE TO RELATED APPLICATIONS

U.S. patent application Ser. No. 12/128,311 Yapaola, et al, Wristband-mounted dispenser for liquids and powders with cm improved dispensing mechanism, discloses a wrist-mounted dispenser with an improved dispensing mechanism. U.S. Ser. No. 12/128,311 is a continuation-in-part of PCT patent application PCT/US06/35681, filed on Sep. 14, 2006, whose inventors are the same as those of U.S. patent application Ser. No. 12/128,311. U.S. Ser. No. 12/128,311 was published as US patent application publication US 2009/0014475 A1.

Three pending U.S. provisional patent applications, each having the same inventors as U.S. patent application Ser. No. 12/128,311, disclose improved versions of the dispenser disclosed in U.S. Ser. No. 12/128,311:

U.S. patent application Ser. No. 61/245,508, Yapaola, et al. Replaceable material chamber for dispenser for liquids or powders, filed Sep. 24, 2009;

U.S. patent application Ser. No. 61/303,110, Yapaola, et al., Clip-on dispenser for liquids or powders, filed Feb. 10, 2010; and

U.S. patent application Ser. No. 61/379,658, Yapaola, et al., A replaceable material reservoir with an integral collapsible material container for a dispenser for liquids and powders, filed Sep. 2, 2010.

The present patent application claims priority from all three of the above provisional patent applications and incorporates all three of the above provisional patent applications, U.S. Ser. No. 12/128,311 and US published application 2009/0014475 by reference for all permissible purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates to dispensers for fluid materials such as liquids or powders and in particular to dispensers of such materials which are small enough to be incorporated into a bracelet and worn on the arm or to be clipped to an article of clothing or an accessory such as a backpack or purse.

2. Description of Related Art

US published application 2009/0014475 disclosed a material dispenser which is small enough to be worn on a wristband, is easy to use, provides measured amounts of the material, has a refillable reservoir, and may be worn with ordinary white-or pink-collar work clothes. The present patent application discloses a material dispenser which is generally similar to the one disclosed in 2009/0014475 but has improvements which solve problems including:

permitting the dispenser to be clipped to a user's garments or accessories;

simplifying the manner in which the dispenser is refilled;

adapting the valves and the passages in the dispenser to the physical properties of the particular material being dispensed;

ensuring that valves and passages do not wear out before all of the material in a reservoir has been dispensed;

simplifying the manner in which a reservoir is replaced;

simplifying the container used to store the material in the reservoir; and

simplifying the manner in which the container is filled.

It is thus an object of the material dispenser disclosed herein to provide solutions to

the foregoing problems.

### BRIEF SUMMARY OF THE INVENTION

In one aspect, an object of the invention is attained by a dispenser for a fluid material which has a dispenser body and a reservoir for the material The dispenser body and the reservoir are separable, may be sold separately, and are assembled by the user. The dispenser body includes a tube which has an open end and a piston which is movable in the tube. There is an air-tight seal between the tube and the piston. The reservoir includes a tube receiving portion which receives the open end of the tube when the reservoir is joined to the dispenser body. When the two are joined, there is an air-tight seal between the dispenser body and the tube receiving portion. The dispenser body further includes a material container which contains the material being dispensed and which collapses under ambient air pressure as the material is removed. There is a passage between the tube receiving portion and the material container. The passage includes a first one-way valve that opens when the pressure in the passage is less than ambient air pressure and a second one-way valve that opens when the pressure in the passage is less than ambient air pressure. As a consequence of the above arrangement of the piston, the passage, and the valves, the material is removed from the material container and expelled from the dispenser in response to the movement of the piston in the tube.

A single dispenser body can be employed with many different reservoirs. Advantages of the fact that the passage and the valves are completely contained in the reservoir are that they can be specifically tailored for the material contained in the reservoir and need only last until the material is consumed.

In another aspect, the reservoir's collapsible fluid container is integral to the reservoir. The collapsible fluid container comprises an interior surface of the reservoir and an elastic barrier that is sealed to the interior surface. The elastic barrier retains a crushed state until it is filled with the fluid. The elastic barrier further has a shape which conforms to the shape of the interior of the reservoir. Consequently, when the collapsible fluid container is filled, it expands from the crushed state to till the reservoir's interior space without internal pressure that is in excess of the ambient air pressure.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 is a view of the material dispenser which shows the dispenser's material reservoir and body and the manner in which they are assembled to form the complete material dispenser;

FIG. 2 is a detail of the material reservoir which shows the integral collapsible material container employed in the material reservoir;

FIG. 3 is a set of cross sections of the material dispenser which show the shape of the collapsible material container; and

FIG. 4 is a detailed longitudinal cross section along the center line of the assembled

material dispenser.

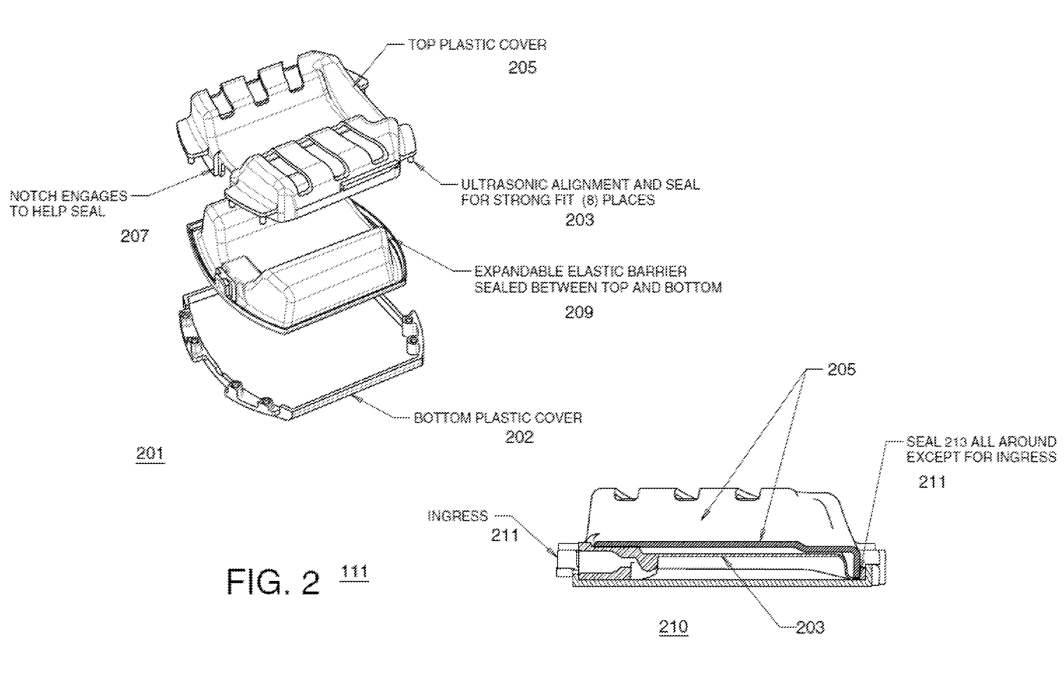

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

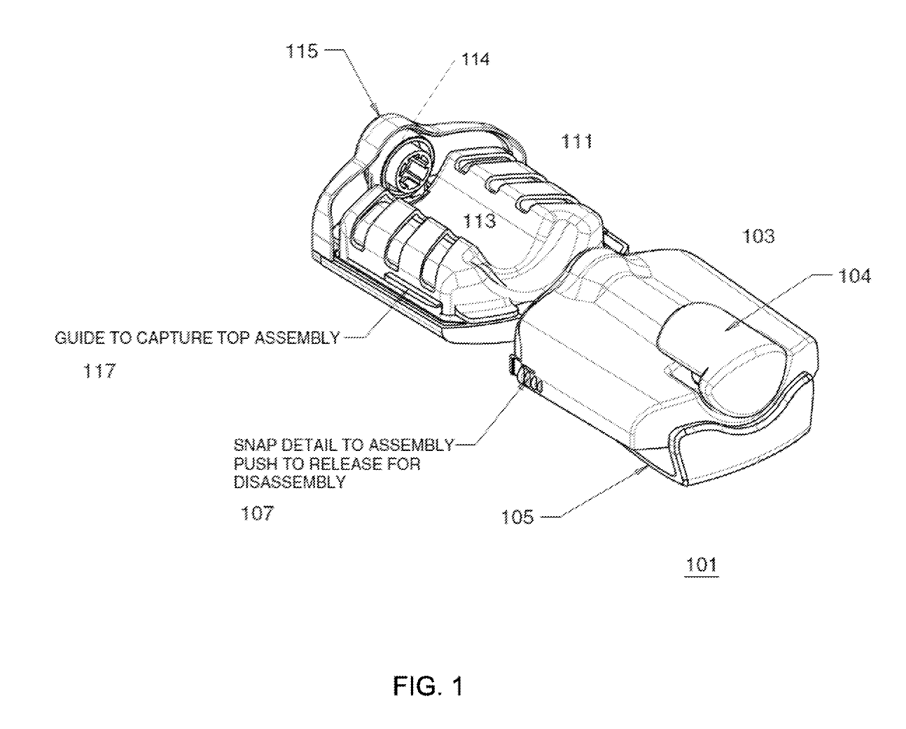

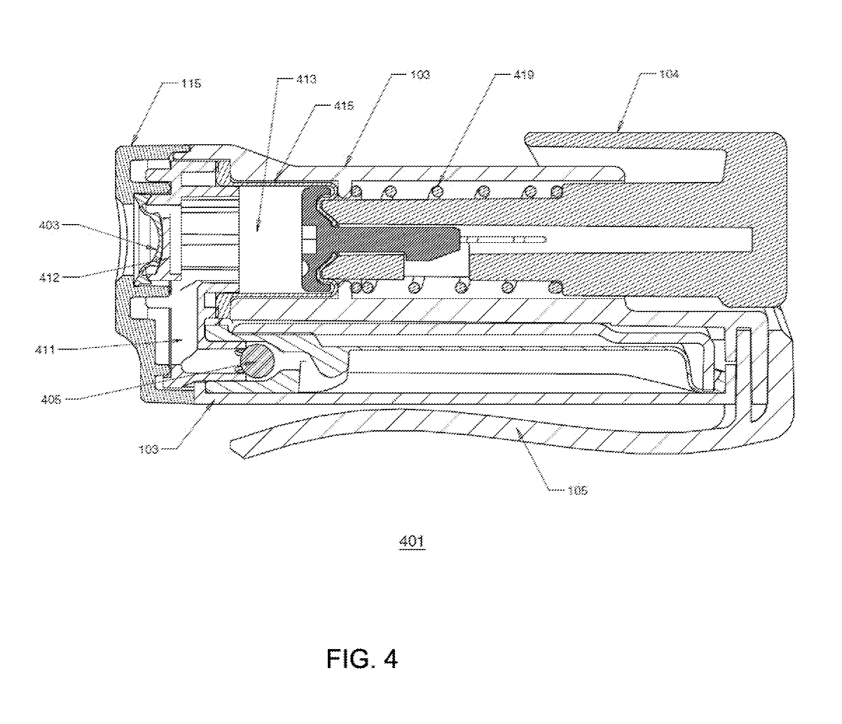

### The Material Dispenser: FIGS. 1 and 4

FIG. 1 is a view of the material dispenser disclosed herein. Material dispenser 101 is a clip-on material dispenser and may be worn on a person's belt, waistband, or pocket or may be attached to an accessory such as a purse or backpack. The improvements which are disclosed in the present patent application are embodied in clip-on dispenser 101. Clip-on dispenser 101 has two major components; body assembly 103 and replaceable material chamber 111. Body assembly 103 contains a piston which moves in a cylinder. The piston is moved by a piston actuator 104. Clip 105 is used to the dispenser onto a belt, a pocket, a back pack, or the like. Replaceable material chamber 111 includes a material container which contains the material (fluid or powder) being dispensed and a nozzle 115 through which the fluid or powder is expelled when the user pushes piston actuator 104 in the direction of nozzle 115. Operation of the piston actuator 104 to expel the fluid or powder is explained in detail below.

FIG. 1 is an exploded view which shows how the two parts making up dispenser 101 are assembled or disassembled by a user of the dispenser. The figure shows how body assembly 103 and reservoir 111 can be assembled by sliding the reservoir into the body assembly using guide 117. A clip shown at 107 releasably retains the reservoir in body assembly 103. Semicylindrical cavity 113 in the reservoir receives the cylinder for the body assembly's piston; when the reservoir and the body assembly are assembled, the structure shown at 114 provides an airtight joint between portion 115 of the reservoir and the piston's cylinder. As will be seen in more detail later, the parts of dispenser 101 which are most likely to wear out or become clogged are all components of replaceable material chamber 111 and are thus replaced each time replaceable material chamber 111 is replaced. A further advantage of this architecture is that the same body assembly 103 may be used with replaceable material chambers 111 which are specially engineered for different kinds of fluids or powders.

The replaceable material chambers may be provided as part of a kit which includes body assembly 103 and a number of replaceable material chambers 111 with the same or different materials to be dispensed. The replaceable material chambers may also be provided separately, and in some instances, body assembly 103 may be provided at no or nominal cost to encourage use or purchase of the replaceable material chambers. For example, where an epidemic disease is spread from hand to hand, public health authorities may distribute body assembly 103, replaceable material chambers full of a disinfectant, and/or the kits in order to reduce the spread of the disease.

FIG. 4 is a vertical section 401 along the center line of a preferred embodiment of assembled dispenser 101. Items shown in detail here are one-way spit valve 403, piston 417, cylinder 413, spring 419, diaphragm 415, structure 114, which mates with cylinder 413, passage 411, which connects the material container and cylinder 413, and ball valve 405 in passage 411. When the user has assembled dispenser 101, diaphragm 415 provides an air-tight seal not only between piston 417 and cylinder 412, but also between cylinder 413 and structure 114.

Dispenser 101 works as follows: Spring 419 normally keeps actuator 104 in the position shown in FIG. 4; the user primes the dispenser by moving actuator 104 towards nozzle 115; piston 417 moves forward in cylinder 413 and compresses the air in cylinder 413 and passage 411. Leakage around piston 417 is prevented by diaphragm 415. The pressure of the compressed air forces spit valve 403 open and ball valve 405 closed and the air exits. When the user releases actuator 104, spring 419 moves it back in cylinder 413, lowering the air pressure in cylinder 413 and passage 411. In response to the lowered air pressure, one-way spit, valve 403 closes, ball valve 405 opens, and the material being dispensed flows from material container 421 through passage 411 into cylinder 413. One-way spit valve 403 opens only in one direction because of backing piece 412, which prevents spit valve 403 from opening when the pressure in cylinder 413 is lower than atmospheric pressure. When the user next moves actuator 104 towards nozzle 115, the pressure produced by the moving piston in cylinder 413 forces spit valve 403 open and ball valve 405 closed and the material being dispensed is expelled through spit valve 403. On the next backstroke of the piston, the air pressure in cylinder 413 is again lowered, valve 403 closes, valve 405 opens, and the material being dispensed again flows through passage 411 into cylinder 413. The amount of material dispensed on each forward stroke of the piston is the amount in cylinder 413.

### Improvements Shown in FIG. 4 Include the Following

spit valve 403 is now located directly at the end of cylinder 413, which simplifies the design of passage 411 and permits the piston to act directly In line with the material exit. This eliminates a convoluted exit path that would make performance and metering less accurate.

diaphragm 415 is now attached to piston 417 around the edges of the piston, which keeps diaphragm 415 from collapsing when piston 417 moves.

ball valve 405, which is made of a synthetic material, requires less space than the one-way valves of the prior embodiments but is equally unaffected by the orientation of the dispenser.

Clip 105 permits dispenser 101 to be clipped to an object such as a belt.

Of course, dispenser 101 could also be attached to a wristband, as disclosed in 2009/0014475.

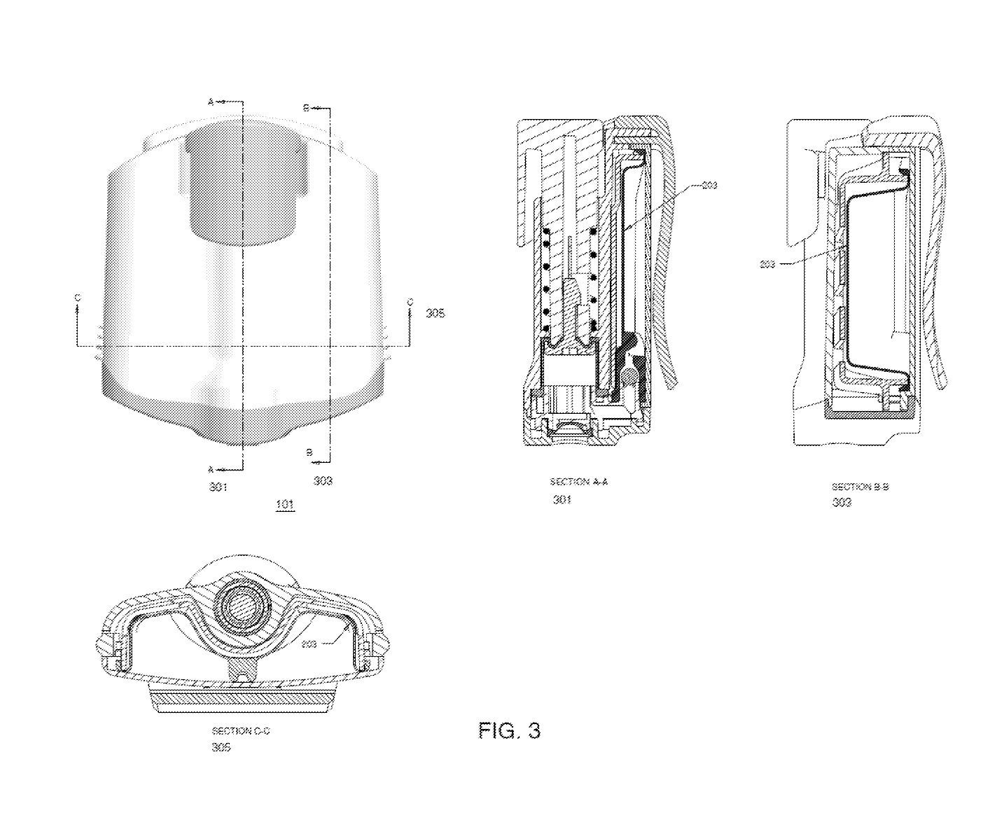

### The Integral Collapsible Materials Container: FIGS. 2 and 3

In the previous versions of the dispenser, the collapsible material container is simply a flexible, air tight bag of the material which is inserted into the reservoir. An example of such a bag is gel bag 617 shown in FIG. 6 of US 2009/0014475. When used in the material dispenser of US 2009/0014475, a bag like gel bag 617 has a number of problems:

The empty bag does not collapse on its own; consequently, before the empty bag can be filled, the air must be withdrawn from it, which complicates the filling process.

The gel bag does not conform closely to the interior shape of the reservoir. The lack of conformity results in two further problems:
The gel bag does not completely fill the available volume of the interior of the reservoir, which reduces the amount of material that can be stored in the reservoir.
If the first problem is overcome by using an elastic gel bag which changes shape as it expands against the interior surface of the reservoir, the result is that the material in the elastic bag has substantial internal pressure, making it more difficult to prevent leakage from the collapsible material container or premature material ejection.
   The problems with the shape of the gel bag increase if, as in dispenser 101, cavity 113 for the body assembly's cylinder occupies a large portion of the volume of the center of the reservoir, dividing the interior of the reservoir into two relatively large volumes connected by a small volume. While causing difficulties for the material container, such a design is otherwise advantageous, since it substantially reduces the total thickness of the assembled dispenser.

Close conformity of the collapsible material container to the interior shape of the reservoir is attained as shown in FIG. 2. The figure shows an exploded view 201 and a longitudinal section 210 of reservoir 111. The reservoir, shown before portion 115 has been added to it, has a bottom plastic cover 202 and a top plastic cover 205. The collapsible container is formed by bottom plastic cover 202 and expandable elastic, barrier 203. There is an air-tight seal 213 between expandable elastic barrier 203 and bottom plastic cover 202 except at ingress 211, which contains a one-way ball valve 405. Elastic barrier 203 has a shape such that when the reservoir is filled with the material to be dispensed, expandable elastic barrier conforms to the shape of the inside of top plastic cover 205, Top plastic cover 205 admits air, and consequently, as the material is pumped out of the reservoir and expelled from the dispenser, elastic barrier 203 collapses under atmospheric pressure. Elastic barrier 203 does not regain its shape after it has been crushed; consequently, it can be crushed after it has been manufactured and it will remain crushed until tilled with the material to be dispensed. This behavior of elastic barrier 203 makes it unnecessary to pump air out of the collapsible container formed by barrier 203 and bottom plastic cover 202 before filling the collapsible container with the material to he dispensed.

Details of a preferred embodiment of elastic barrier 203 are shown in FIGS. 2, 3, and 4. As best seen in FIG. 4, elastic barrier as molded includes egress 211 and the material necessary for seal 213. Seal 213 is formed by clamping the edges of elastic barrier 203 between bottom plastic cover 202 and top plastic cover 205. A system of pegs in the top plastic container cover and sockets in the bottom plastic cover hold the two tightly together with the edges of expandable elastic barrier clamped between them, as shown at 209. FIG. 3 shows a top view of the fully assembled material dispenser 101 and three cross sections: one, 301, along the center line of the assembled device, i.e., along the center line of body 103, one, 303, along one of the high portions of the reservoir, and a transverse cross section 305. Between the three, the relationship between the shape of elastic barrier 203 and the reservoir's cavity Is clear. Cross section 301 also shows the one-way valve at ingress 211 of the collapsible container and the relationship between the collapsible container, the piston, the cylinder, the spit valve, and the nozzle. For further details, see FIG. 4 and its discussion above.

Further Details of a Presently Preferred Embodiment of the Integral Materials Container

In a preferred embodiment, two materials are being considered for elastic barrier 203: silicon and a molded polyurethane. The silicon has a better range for the properties we desire for barrier 203, but the urethane might be more cost-effective in high-volume. The desired properties are strength with elasticity, and being reliable in a thin (about 0.010″) wall thickness. The material of the elastic barrier should be resistant to reacting with the contained fluid. The elastic barrier should have a good shelf life after the reservoir has been filled with the material to be dispensed. Silicon and urethane are good families for such properties. For our initial models, we will use a silicon.

Sealing the Elastic Barrier To The Bottom Cover

It is important to keep the internal pressure of the fluid in the collapsible container low. One reason for this is the seal of the barrier's perimeter. The seal is being made by pinching the elastic barrier's perimeter between bottom cover 202 and top cover 205 (the pinching is best shown in sections 301, 303, and 305). To add tightness and hold this sandwich in place, I use ultrasonic welding to weld a pin into a hole at eight positions, as seen at 209. Fastening the top and bottom plastic covers in this way will be reinforced by maintaining a stiffness in the top cover and a curvature (seen at 305) to the bottom cover, which will all assist in maintaining pressure around the barrier perimeter. With low internal pressure of the fluid, the above seal should be sufficient.

Filling the Collapsible Container Made Using the Elastic Barrier

Filling the container is intended at this point to be done at the factory. Key to maintaining the low internal pressure is the shape of elastic barrier 203. It must be shaped such that there is a minimal amount of backpressure built up when the reservoir is full. The elastic barrier will be contoured to the internal cavity, but because of the thin wall, the elastic barrier will arrive to this assembly stage flattened and will expand only when filled with the substance to be dispensed. The reservoir is assembled with the elastic barrier as described above. The reservoir with the elastic barrier is turned upward so that ingress 211 is facing upward. The reservoir is filled with low positive pressure and the assistance of gravity. The barrier expands to fill the reservoir, and little air is trapped inside the elastic barrier. After the appropriate amount of the substance has been placed in the reservoir, ball 405 is placed in egress 211 and structure 404 of assembly 115 is mated with egress 211. Egress 411 and ball valve 405 thereby become part of passage 411. There will be a paper seal over the hole in assembly 115 which receives the cylinder. The seal will be removed by the user when combining the reservoir with the body assembly.

Dispensing Material After the Reservoir has been Combined with the Body Assembly

Invariably, some air will get trapped in the bag and channels when the reservoir is combined with the body assembly. This is a good thing because it keeps the reservoir from leaking while it is being combined with the body assembly. The initial strokes of the piston will pump air as well as fluid, so there will be an initial “priming of the pump” action required. As the fluid is dispensed, the elastic barrier will collapse under the ambient air pressure.

### Conclusion

The foregoing Detailed Description has disclosed to those skilled in the relevant technologies how to make and use the dispenser which Is disclosed herein and has further disclosed the best mode presently known to the inventors of making and using the dispenser. Details of dispensers like those disclosed in the Detailed Description will depend on the purpose of the dispenser, the kind of fluid it is dispensing, and the materials available to build the dispenser. In particular, it is to be understood the term “fluid” used herein includes not only liquids and powders, but any substance which behaves like a fluid For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

1. A dispenser for a fluid material, the dispenser comprising:
a dispenser body including
a tube which has an open end and
a piston which is movable in the tube, there being an air-tight seal between the tube and the piston; and
a reservoir for the material which is separable from the dispenser body, the reservoir including
a tube receiving portion which receives the open end of the tube when the reservoir is joined to the dispenser body, there being an air-tight seal between the received open end of the tube and the tube receiving portion;
a material container which contains the material and collapses under ambient air pressure as the material is removed from it;
a passage between the tube receiving portion and the material container, the passage including
a first one-way valve that opens when the pressure in the passage is less than ambient air pressure and
a second one-way valve that opens when the pressure in the passage is greater than ambient air pressure,
whereby the material is removed from the material container and expelled from the dispenser in response to movement of the piston in the tube.

2. A body for a dispenser of a fluid material, the dispenser being made by a user joining the body to a reservoir for the fluid material, the reservoir including a passage, valves for the fluid material, and a container for the fluid material, and the body comprising:
a piston;
a tube in which the piston is movable, there being an air-tight seal between the piston and the tube and the tube having an open end which the user joins to the reservoir by inserting the open end into a tube receiving portion of the reservoir, there being an air-tight connection between the inserted open end of the tube and the tube receiving portion, the passage extending between the container for the fluid material and the tube receiving portion, and the valves responding to pressure changes resulting from movement of the piston in the tube to cause the fluid material to be removed from the container for the fluid material and expelled from the dispenser.

3. A reservoir for a dispenser of a fluid material, the dispenser being made by a user joining the reservoir to a dispenser body that includes a tube with an open end and a piston, there being an air-tight seal between the piston and the tube and the piston being movable in the tube and
the reservoir comprising:.
a tube receiving portion which receives the open end of the tube when the reservoir is joined to the dispenser body, there being an air-tight seal between the received open end of the tube and the rube receiving portion;
a material container which contains the material and collapses under ambient air pressure as the material is removed; and
a passage between the tube receiving portion and the material container, the passage including
a first one-way valve that opens when the pressure In the passage is less than ambient air pressure and
a second one-way valve that opens when the pressure in the passage is greater than ambient air pressure,
whereby the material is removed from the material container and expelled from the dispenser in response to movement of the piston in the tube.

4. The reservoir set forth in claim 3 wherein:
the second one-way valve is located at the tube receiving portion end of the passage.

5. The reservoir set forth in claim 4 wherein:
the first one-way valve is located at the material container end of the passage.

6. The reservoir set forth in claim 3 wherein:
the passage need only function until the fluid is exhausted.

7. The reservoir set forth in claim 3 wherein:
the fluid material belongs to a material type of a plurality thereof;
the passage is designed specifically for the material type of the fluid material in the reservoir; and
the reservoir for any material type accepts the body's tube.

8. The reservoir set forth in claim 7 wherein:
the passage designed for the material type takes into account a physical property of the material type's fluid.

9. The reservoir set forth in claim 7 wherein:
the material container is integral with the reservoir.

10. The reservoir set forth in claim 3 wherein the reservoir has an interior cavity and the material container comprises:
a surface of the interior cavity and
an elastic harrier that is sealed to the surface.

11. The reservoir set forth in claim 10 wherein:
the interior cavity has another surface; and
the elastic barrier has a shape that conforms to the other surface.

12. The reservoir set forth in claim 10 wherein:
when the material container is full of material, the pressure inside the material container is substantially the ambient air pressure.

13. The reservoir set forth in claim 10 wherein:
when crushed, the elastic barrier remains crushed until filled with the fluid.

14. A collapsible fluid container which is integral to a rigid containing structure, the collapsible fluid container comprising:
an interior surface of the containing structure; and
an elastic barrier that is sealed to the interior surface, the elastic barrier retaining a crushed state until being filled with the fluid.

15. The collapsible fluid container set forth in claim 14 wherein:
the containing structure has another interior surface; and
the elastic barrier has a shape which conforms to the other interior surface, whereby the collapsible fluid container, when filled, expands from the crushed state to fill the space between the interior surface and the other interior surface without internal pressure that is in excess of the ambient air pressure.
